(19) United States
(12) Patent Application Publication
(10) Pub. No.: US 2020/0209868 A1
(43) Pub. Date: Jul. 2, 2020

(54) NAVIGATION METHOD AND NAVIGATION DEVICE

(71) Applicant: INNOVATIVE DRAGON LTD., London (GB)

(72) Inventor: Herwig FISCHER, Willich (DE)

(21) Appl. No.: 16/640,565

(22) PCT Filed: Jul. 11, 2018
(86) PCT No.: PCT/EP2018/068785

§ 371 Date: Feb. 20, 2020

(30) Foreign Application Priority Data
Aug. 23, 2017 (DE) 10 2017 007 984.6
Sep. 20, 2017 (DE) 10 2017 008 830.6
Oct. 7, 2017 (DE) 10 2017 009 338.5

(51) Int. Cl. G05D 1/02; G01S 13/58; G01S 13/87; G01S 5/02; G01S 13/931; G01S 17/931; G01S 17/58; H04W 4/44; G01C 21/30; G08G 1/01; G08G 1/04; G08G 1/052

(52) U.S. Cl. CPC G05D 1/0214; G05D 2201/0213; G01S 13/876; G01S 13/878; G01S 5/0289; G01S 13/931; G01S 17/931; G01S 17/58; H04W 4/44; G05D 1/0291; G05D 1/0276; G01C 21/30; G08G 1/0116; G08G 1/04; G08G 1/052; G01S 2013/9321; G01S 2013/9329; G01S 13/589

(57) ABSTRACT

A navigation method and a navigation device for performing a navigation method are provided for at least one self-driving road vehicle within a restricted region. In order to in particular specify a navigation device and a navigation method that allows for autonomous driving in a restricted region in a reliable and cost-effective manner, a plurality of stationary stations are provided, each including a transceiver unit, to be arranged in the restricted region. The stations can be wirelessly connected to a transceiver unit of the vehicle for the purpose of data exchange. A position and the speed of the vehicle can be clearly determined, based on a propagation time of a signal from the transceiver unit of the vehicle to at least two stations, and back.

### CROSS REFERENCE TO RELATED APPLICATIONS

This application is a United States National Phase Application of International Application PCT/EP2018/068785, filed Jul. 11, 2018, and claims the benefit of priority under 35 U.S.C. § 119 of German Applications 10 2017 007 984.6, filed Aug. 23, 2017, 10 2017 008 830.6, filed Sep. 20, 2017 and 10 2017 009 338.5, filed Oct. 7, 2017, the entire contents of which are incorporated herein by reference.

### TECHNICAL FIELD

The present invention relates to a navigation method and a navigation device for performing a navigation method for at least one self-driving road vehicle within a restricted region.

### TECHNICAL BACKGROUND

Autonomous driving is currently a principle topic of various mobility concepts. An attempt is generally made, in this case, to replace the driver of passenger and goods vehicles, such as passenger cars, utility vehicles and trucks, with autonomous systems, for which purpose the driver's perception is simulated by various sensors. In this case, the simulation of the vision, including identification of markings on the road surface, traffic signs, signaling installations (traffic lights, road signs, etc.) and other road users is very susceptible to interference. In particular back-light, in the event of setting sun, or water, snow and ice on the carriageway, regularly leads to incorrect identifications. In addition, the necessary cartography requires an extremely large amount of data, which makes it more difficult to implement known mobility concepts.

Furthermore, satellite-assisted navigation methods for self-driving vehicles are also known, which is also associated with disadvantages because, in narrow street canyons of modern inner cities, the signals are often shielded, at least in regions, even when there are additional base stations (DGPS or RTK), and therefore sufficiently precise control of the vehicles is prevented.

As a result, the control procedure of a human is copied in the case of the known systems. The usually GPS-assisted trajectories that are delivered from outside are used only for navigation, i.e. for selecting the route and for determining the route to the destination, whereas the vehicle guidance is performed by means of signals which are designed in a manner similar to visual perception. The same is achieved by evaluating signals from camera images, radar/LIDAR signals, or from different wheel speeds of the vehicles, from which bend radii can be calculated. In each case, the division of tasks is still that of specification of the route selection by an external system, where a determination is made regarding the roads via which the journey to the destination is to take place, and roadway control by onboard systems of the vehicles which are based on the perception criteria of a human driver.

The known operating principles can, in summary, be described such that the autonomous control copies the perceptive abilities of a human driver, in that it is based on the same information sources and in addition transfer said perceptions into an image of the surrounding reality, in a manner having sophisticated and error-free shape identification, and thus simulate a human driver. Both with regard to the sensor system, and in data processing, these operating principles result in requirements which cannot be met or can be met only with very great effort, and nonetheless with almost unavoidable safety breaches.

Approaches are also known in which the autonomous driving is performed using infrastructure devices, such as contact wires, magnets or induction loops. These systems are suitable only to a limited extent for control of vehicles in city-center regions, because installations of this kind in the road surface are complex, costly, and prone to failure as a result of weather-related influences such as rain, snow and ice. Furthermore, installations outside the road surface are susceptible to destruction by road sweepers and snow-clearing vehicles.

### SUMMARY

Proceeding here from, an object of the present invention is that of specifying a navigation device and a navigation method by means of which the disadvantages of the prior art can be overcome at least in part. In particular, a navigation device and a navigation method are to be specified, which allow or autonomous driving in a restricted region, in a reliable and cost-saving manner.

### 1. Navigation Method

This object is firstly achieved by the navigation method according to the invention wherein a plurality of stationary stations, each comprising a transceiver unit, are arranged in the restricted region, which stations can be wirelessly connected to a transceiver unit of the vehicle for the purpose of data exchange, such that the position and the speed of the vehicle can be clearly determined, by means of the propagation time of a signal from the transceiver unit of the vehicle to at least two stations, and back, is determined.

According to a first preferred embodiment of the invention, the vehicle is a vehicle from a fleet of a plurality of vehicles that can be driven autonomously and individually. In this connection, “individual” means that the vehicles can travel different routes, independently of one another.

The propagation time T of the signal preferably results from the propagation time T₁ of the signal from the transceiver unit of the vehicle to a station, the data processing time T₀, and the propagation time T₂ of the signal from a station to the transceiver unit of the vehicle.

In particular, the signals comprise identification features of the transmitting transceiver units. The identification features are modulated onto the signals by the transmitting transceiver units, and allow for clear association of the vehicles and stations.

Accordingly, for the purpose of exact position and speed determination and for driving route control, the vehicle emits a substantially omnidirectional signal at specified time intervals. In the case of the known radar or LIDAR systems, in contrast, directional signals are emitted. The omnidirectional signals contain a code for identifying the vehicle and reach only relatively small ranges, with the result that the necessary transmission power is low. The signal is received in the transceiver unit of the nearby stations, and radioed back, together with an identification feature of the station, following a precisely specified time interval.

The transceiver unit in the vehicle thus receives the return signal within an exactly definable time window which is composed of the propagation time T₁ of the signal to the station, the always identical return interval T₀ (data processing time), and the propagation time T₂ from the station back to the vehicle. As a result, the position and speed can be exactly determined from the overall propagation time T. At the time of the measurement, the vehicle is located on a defined spherical surface, at a distance from a station. Since the vehicle must be located on the ground, the number of possible positions of a spherical surface is reduced to the intersection of the road surface with the spherical surface, i.e. to a line. An intersection point that marks the position of the vehicle then results by means of a bearing to a further station which similarly defines a line (curve).

In the possible event of both the determined curves resulting in two intersection points, either a third location and speed determination is made, via a further station, a plausibility check is made using one of the previous bearings, or the bearing is not used. In any case, in the event of three bearings an exact, one-to-one position of the vehicle is determined. If the stations are mapped exactly, a vector space can thus be defined as the driving route, which requires only a small data volume in comparison with a road map or video image material.

The processing time T₀ may be a fixed value or variable, wherein in the latter case the time T₀ actually used for each bearing is also radioed back, such that the position determination is clear. A variation of this kind is expedient, or even required, if a plurality of vehicles is connected to the same stations and the data are not processed synchronously.

In contrast with conventional radar or LIDAR systems, a directional bearing is not required. Identification errors are prevented, and complex synchronization of the clocks, as is the case in unilateral systems (GPS) can be omitted, because it is not times, but rather time intervals, that are measured, and the respective positions of the stations are fixed.

The evaluation algorithm of the propagation times and the position of the stations can be performed in real-time, and the stored correction factors for the intended driving route (trajectory) can be stored in a library.

In a particular embodiment, a direct correction algorithm is stored, which determines and implements the correction data for controlling the vehicle, instead of determining the position from the identified data and the target/actual deviation.

In a further preferred embodiment of the invention, the bearing starts from the stationary stations, and the transceiver unit, designed as a transponder, is located in the vehicle. In this case, the station emits correction data for the trajectory, in addition to the bearing. The advantage of this embodiment is that the library of the trajectories in each station requires far less data volume, since only the transmission region of the relevant station is stored, and not the entire restricted region in which the vehicles can travel.

In order to prevent propagation time errors, e.g. reflex radiation, a radio sequence is selected which causes few reflections on the surrounding surfaces.

The transmitted data are preferably digitized. In a preferably embodiment, the data is transmitted in packets, such that standing continuous signals are not required.

In a further embodiment of the invention, the data transmitted by the transceiver units and/or the driving route correction data are transmitted to a control center. Said data are then optimized by means of what are known as artificial intelligence systems or other learning routines, and the results are used in the available libraries and/or in the algorithms for continuous improvement and adjustment.

According to a further preferred embodiment of the invention, the stationary stations are also used as WLAN stations and charging controller and for invoicing.

In order for the self-driving vehicles to be controllable on specifiable paths, within the restricted region, the restricted region is mapped. Vectorial mapping is preferably provided. In order that the restricted region can be recorded vectorially, exactly and in a manner having a minimum data volume, firstly every street portion, i.e. the roadway between T-junctions and crossroads, is depicted as vector graphics.

Crossroads and T-junctions are described in two more categories, having a suitable transition radius of the intersecting portions in each case, e.g. in a narrow radius for acute-angled crossroads of narrow carriageways, and a large radius for obtuse-angled junctions of wide carriageways.

Each route portion is denoted by a path length marking.

The roadways are attributed an offset value from the center point.

Once the mapping has been completed, all routes are driven using real vehicles, and the vector data are checked.

All the vehicles of the fleet of self-driving vehicles then receive software by means of which the onboard controller can drive the vectorized routes again. The offset values are taken into account in this case. For example, one vehicle is moving on the inside lane, at a distance of 0.7 m from the center, and another vehicle is moving on the outside lane, at a distance of 1.4 m, with the result that the vehicles, driving in parallel, are guided in an optimum manner. In this case, hard shoulders can also be specified, for getting into and out of the vehicles.

Deviations due to tolerances or an accumulation of disturbance variables are identified by the signals of the CPS, from the stationary stations, and corresponding corrections are made.

The sequence of the driving route determination is therefore typically the following:

A passenger sends a call signal comprising his journey destination to a control center, using a mobile telephone, preferably by means of an app. The position of said passenger when making the call is automatically also sent. These positions are based on the known GPS signals. A computer in the control center (or also in the next vehicle of the fleet) determines the corresponding position data of the vectorized roadways on the basis of the GPS data. Using Dijkstra's algorithm, known from the prior art, the shortest route is subsequently determined. Alternatively, the quickest route can also be selected, in that the route portions are not assigned distances, but instead travel times. The data required therefor are acquired centrally from current logs of the active (traveling) autonomous vehicles of the fleet.

The route optimization is performed in the control center or onboard in each vehicle of the fleet.

In this case, the route guidance takes account of data for the offset of the track from the center line, as well as a further offset which results from the receiving antennae not being located at the height of the road surface, but instead higher. Optimally, receiving antennae are arranged on the roofs of the vehicles, and, in the event of possible lateral tilting of the vehicle, a lateral deviation between the trajectory of the wheels and the trajectory of the antennae is to be taken into account.

In the present navigation method, the vehicles are not guided by feature that can be acquired optically or by means of radar/LIDAR, such as curbsides or road markings, but rather by vectorially acquired, highly precise guideways that are transmitted in an interference-proof manner via short-range radio and are not subject to any wear or soiling, e.g. from standing vehicles, snow or ice. Irrespective thereof, the system can be corrected both by means of direct video transmission or by pointwise checks.

In a preferred embodiment of the invention, when determining the location the signals are coded such that a direction-finding beam can be used as direction determination, and one or more signals, modulated on, can be used for distance determination, such that precise position determination is possible, even having just one transmitter in the reception region. For the purpose of redundancy, however, use is made of all available transmission signals with cross bearings.

In the event of a vehicle passing a point or a region in which a signal should be available, but no signal is received, the vehicle transmits a signal comprising an error message, to the control center of the restricted region.

In a particular embodiment, the described transmitters, in particular the radio transmitters, are combined with a WLAN system, as a network, in the case of which large regions, for example entire districts, are supplied with public WLAN. For this purpose, some of the individual stations are designed as repeaters, such that data is forwarded only from one station to the next, and separate data guidance to each station can be omitted. Said WLAN data can then be used in parallel, for navigation of the vehicles.

In a further embodiment, the vehicles communicate not only using the described radio transmitters, but also using the signals from mobile telephones in the immediate vicinity, such that moving participants, such as other passenger cars, pedestrians and cyclists can be detected.

### 2. Navigation Device

The object mentioned at the outset is additionally achieved by the navigation device for carrying out the navigation method. According to the invention, for this purpose a plurality of stationary stations, each comprising a transceiver unit, are arranged in the restricted region, which stations can be wirelessly connected to a transceiver unit of the vehicle for the purpose of data exchange and for the purpose of determining the position and speed of the vehicle. A signal network is thus propvide, in which radio signals having a short range are transmitted in narrow spacings, preferably between 10 m and 50 m, which signals contain digitized information relating to the position of the transmitter, traffic situations, and other data for reliable vehicle guidance.

In order to reduce the high costs and the complexity when installing the navigation device, according to a preferred embodiment of the invention transceiver units of the stationary stations are connected to the power supply of energized infrastructure elements, in particular to the power supply of traffic lights, street lamps, information signs, advertising billboards, and/or other illuminations. When the transceiver units are arranged in energized traffic signaling installations, it is possible to exploit the fact that not only is the current source available and usable, but rather it is also possible to transmit the information relating to the traffic situation, such as temporally variable speed limits or traffic light signals, for controlling traffic priority. In practice, all energized installations of this kind in city centers are also based on quasi optical signal propagation, because the driver must be able to see the traffic signs, and therefore there is no shielding by obstacles.

According to a particularly preferred embodiment of the invention, the transceiver units of a stationary station are arranged between the base and the illumination means of the energized infrastructure element. Furthermore, for the purpose of power supply the transceiver units of a stationary station preferably comprise a connector which corresponds to the connector geometry of the illumination means of the energized infrastructure element. When using lamps, the transceiver unit can thus be screwed into the tread of the (former) illumination means, which provides the additional advantage that the height alone of the position of the illumination means ensures reliable signal transmission.

### 3. Sector Monitoring

In particular in urban traffic, self-driving vehicles must have not only very precise roadway control and position determination, but must also identify obstacles on the roadway, or already anticipate, by means of identification technology, if movable obstacles such as other road users are moving on a collision course. Owing to the high traffic density in urban traffic, the view of obstacles of this kind is often restricted, and therefore even the particularly powerful systems provide only a limited remedy.

According to a particularly preferred embodiment of the invention, the stationary stations comprise sensors which allow for obstacle identification by means of suitable software. The sensors are preferably cameras, radar sensors, LIDAR sensors or ultrasound sensors. In order to be supplied with power, the sensors are connected to the power supply of the stationary stations, with result that there is little installation outlay.

The obstacle identification is suitable for all applications in which data exchange takes place among the vehicles of the fleet, and/or between the vehicles and a control center, and/or between the vehicles and individual guide means, such that information relating to possible obstacles can be directly forwarded to vehicles in the sector in question.

The sensors are preferably combined with position acquisition and roadway acquisition of vehicles in the observation region of the obstacle identification systems. The vehicles enter into a dialogue with the stations as soon as they reach the recorded region, and are provided directly, via radio/WLAN/NFC, or the like, with the information relating to possible obstacles.

The particular advantages are that
obstructions of the observation route do not occur, or occur only to a reduced extent and less frequently, as a result of the high position,
in contrast to acquisition systems that are mounted on a vehicle, the background image remains substantially identical, and thus the shape identification is much easier,
any change, i.e. any movement of an object in the observation space, can be simply and reliably identified in that the pixels of a first image are subtracted from the pixels of a second image, and the remaining difference must therefore represent the changes, for example a moving pedestrian entering the observation space,
movement directions can be identified by simple pixel comparison operations, using a similarly simple algorithm,
determination of obstacles that arise takes place much earlier, even before a vehicle is within view, and
obstacles are detected even at night, since a lamp, as a stationary station, simultaneously ensures illumination.

Known systems for collision avoidance are fastened to vehicles and can thus record only a very small space in front of the vehicle, because, at bends, they can be oriented towards the driving route only to a limited extent, obstacles such as other vehicles driving ahead, approaching or parking to the side, or signs, are in the way, and shape identification software must constantly align itself to changing background scenes. The latter situation results in the identification either requiring extremely high processing power, or the need to store a background library for the entire traffic region, with the result that a very high data volume has to be processed.

Shape identification software operates such that changes in an observation space are recorded by means of digitization and/or vectorization, and these changes are converted and assigned to a shape. In this case, changing perspectives, illumination states or background images are significant disturbance variables, because the identified image deviates from the stored image, and it is necessary to first calculate which of the deviations are disturbance variables and which are target variables.

On a traveling vehicle, the background, illumination and perspective change continuously, with the result that the acquisition and identification of target variables is very difficult and prone to interference.

In contrast, a fixedly installed sensor always “sees” the same image of the observation space (sector) that changes at most on account of the illumination. However, such changes are easily compensated by stored daytime and night-time images, and possibly seasonal images. Collective changes such as illumination or seasonal influences can also be easily distinguished from changes by moving objects, by means of the number of changes pixels being recorded. Falling dusk changes a very large portion of pixels in the image, by a very small quantitative amount per time unit, in the form of a continuous color change, whereas a vehicle or a pedestrian entering the observation space generates a high-contrast color change in a few pixel portions.

Any further change extending therebeyond must be a moving object that has to be located only in order to identify whether or not it could collide with the approaching vehicle. This spatial association can very easily be achieved by means of software, in that the routes of vehicles can be recorded vectorially, or in an analogue manner, or as a pixel shape, in the recorded region. Vehicles are then warned and prepared for braking, before they can identify obstacles themselves. In addition, this obstacle identification as a separate system without common subsystems shared with the vehicles constitutes complete redundancy with respect to the existing obstacle identification in vehicles. In the event of discrepancy between the two systems, a plausibility check is performed, and a decision is made on the basis thereof In any case of doubt, the readiness for braking is increased as a precaution. In addition, the stationary and/or the mobile system emits a signal as a light flash or acoustic flash, and warns of the obstacle.

For autonomously operating mobility concepts of this kind, the operation of which is restricted to a particular space, the costs are also reduced, because fewer stations than vehicles have to be issued. Stationary installation is also more cost-effective.

In a particular embodiment, the stationary unit also identifies radio signals from mobile telephones as decision aids when identifying obstacles.

Furthermore, the system according to the invention also records the passage of the vehicles, and thus delivers redundant feedback to the roadway control, which is performed by the vehicle alone or using a bearing system that is attached in the vicinity or at the same point.

In the case of obstacles that are identified by external or by onboard systems of the vehicles, an avoidance trajectory is calculated that is determined as a vector having an offset from the mapped center line vector, plus the transition radius around the obstacle region. The vehicles are thus guided on virtual tracks that correspond to mathematical curves, and not on point clouds having an endless number of possible variations.

Thus, when an obstacle is encountered, the following sequence results:

On its travel along the selected, vectorial trajectory, the self-driving vehicle approaches an obstacle that is initially recorded by the external camera in the lamp, as a result of which a first warning signal is transmitted to the vehicle and the speed is reduced. As soon as the obstacle is also recorded by the onboard system of the vehicle, the two systems, i.e. the onboard and the stationary system, adjust the optimum detour route, and the detour takes place only following correspondence and clearance of the detour stretch by the two systems. In parallel therewith, the detour is logged, together with the time, at the control center.

In summary, in contrast with the prior art, the present invention proposes an entirely different operating principle, in which a vectorial and sufficiently precise image of the surrounding reality is created and conveyed from an external transmission system to the vehicles, such that no accuracy gap remains which has to be closed by means of the described guidance by optical signals or radar/LIDAR signals. Instead, the vehicles move directly on the virtual tracks which are mapped as a vectorial image of the surroundings. As a result, the inner perception for the vehicle guidance is a vector graphic having a very compact data volume that can be easily and reliably stored and processed. The primary route guidance, i.e. precise following of the trajectories, is possible if the data transfer between the control source and the vehicle is ensured.

The secondary vehicle guidance, i.e. bypassing obstacles and avoiding collisions, requires a solution that is adjusted to the navigation method according to the invention, if the vehicles are intended to operate autonomously, in the restricted region, in parallel with other road users. For this purpose, the specified vectors are also used. It is therefore not necessary to consider an endless number of options that the vehicle has to process in a situational manner. Instead, an external system is also provided, which system identifies any obstacles by means of simple and computer-compatible methods, and transmits reactions thereto, from a likewise vectorial scenario, to the vehicle in real-time.

As a result, both the imaging of the surroundings and the primary and secondary vehicle guidance take place in a digital and vectorial manner, and no longer by means of pixel images and analogue routines.

The present invention is thus additionally advantageous in comparison with methods known from the prior art, because the recorded data can be directly evaluated as raw data, which is associated with a significant reduction of the computing capacity. In contrast, in known methods it is necessary to amalgamate the data from various sensors (camera, LIDAR, radar), increasing the requirements for processing power, and as a result of which the reaction time to unpredictable events also increases.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a view showing a restricted region; and

FIG. 2 is a schematic view showing a road portion.

### DESCRIPTION OF PREFERRED EMBODIMENTS

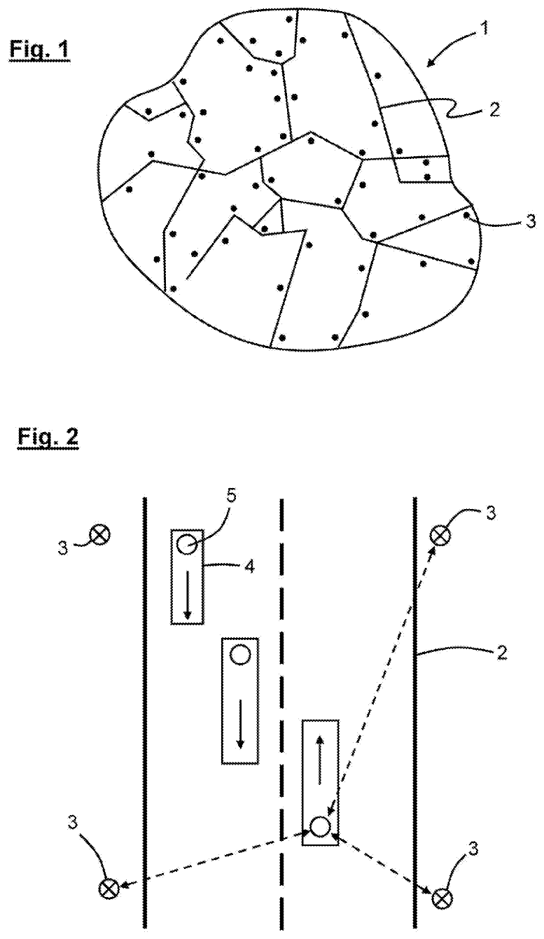

Referring to the drawings, FIG. 1 shows a restricted region 1 in which the vehicles of the fleet can drive autonomously. The restricted region is for example a town or an inner-city area and contains various streets 2 that have crossroads and T-junctions. Stationary stations (indicated by black dots in FIG. 1) are arranged along the street 2, which stations have transceiver units 3. As shown in FIG. 2, the vehicles 4 likewise have transceiver units 5, and therefore clear position and speed determination can be performed by measuring the signal propagation time to at least two, three, or more stationary stations. The vehicles can subsequently move on the mapped routes of the restricted region 1 by means of suitable controls.

While specific embodiments of the invention have been shown and described in detail to illustrate the application of the principles of the invention, it will be understood that the invention may be embodied otherwise without departing from such principles.

1. A navigation method for at least one self-driving road vehicle within a restricted region, the method comprising the steps of:
arranging a plurality of stationary stations, each comprising a transceiver unit, in the restricted region;
connecting the stations wirelessly to a transceiver unit of the vehicle for the purpose of data exchange; and
determining a position and speed of the vehicle by means of a propagation time of a signal from the transceiver unit of the vehicle to at least two stations of the plurality of stationary stations, and back.

2. A navigation method according to claim 1, wherein the vehicle is from a fleet of a plurality of vehicles that can be driven autonomously and individually.

3. A navigation method according to claim 1, wherein the propagation time of the signal results from a vehicle to station propagation time of the signal from the transceiver unit of the vehicle to a station, a data processing time, and a station to vehicle propagation time of the signal from a station to the transceiver unit of the vehicle.

4. A navigation method according to claim 1, wherein the signals comprise identification features of the transmitting transceiver unit.

5. A navigation method according to claim 1, wherein all routes of the restricted region on which the vehicles can travel are mapped.

6. A navigation method according to claim 5, wherein the mapping comprises vectorial mapping.

7. A navigation according to claim 1, wherein roadway control in a vectorial space is performed without sensors, such that infrastructural identification features of the surroundings are not recorded by means of camera systems or radar/LIDAR systems.

8. A navigation method according to claim 1, wherein the vehicles is guided on vectorial trajectories recorded and communicated precisely, and therefore the vehicle is not guided by means of image acquisition of center lines or curbsides.

9. A navigation method according to claim 1, wherein vectorial roadways in each sector of the restricted region are recorded in camera images of the stationary stations as virtual tracks, such that every static image of the stationary stations comprises a course of all available roadways, as a result of which it is possible to directly identify whether any obstacle is permanently or temporarily blocking a roadway.

10. A navigation device for carrying out a navigation method for at least one self-driving road vehicle within a restricted region, the navigation device comprising:
a plurality of stationary stations, each comprising a transceiver unit, wherein the plurality of stationary stations are arranged in the restricted region, which stations can be wirelessly connected to a transceiver unit of the vehicle for the purpose of data exchange and for the purpose of determining the position and speed of the vehicle.

11. A navigation device according to claim 10, wherein the transceiver units of the stationary stations are connected to the power supply of energized infrastructure elements comprising traffic lights, streetlamps, information signs, advertising billboards, and/or other illuminations.

12. A navigation device according to claim 11, wherein the transceiver units of a stationary station are arranged between the base and the illumination means of the energized infrastructure element.

13. A navigation device according to claim 11, wherein the transceiver units of the stationary stations each comprise a connector which corresponds to a connector geometry of the illumination means of the energized infrastructure element to supply power to the stationary station.

14. A navigation device according to claim 10, wherein the stationary stations comprise sensors which allow for obstacle identification.

15. A navigation device according to claim 10, wherein the stationary stations comprise a sensor; and
the sensor comprises a camera, a radar sensor, a LIDAR sensor or an ultrasound sensor.

16. A navigation system for carrying out a navigation method for at least one self-driving road vehicle within a restricted region, the navigation system comprising:
a plurality of stationary stations, each comprising a transceiver unit, wherein the plurality of stationary stations are each arranged in the restricted region; and
a transceiver unit of the vehicle, the transceiver unit being connectable wirelessly to the plurality of stationary stations for data exchange therebetween such that a position and speed of the vehicle is determined, by means of a propagation time of a signal from the transceiver unit of the vehicle to at least two stations of the plurality of stationary stations, and back.

17. A navigation system according to claim 16, wherein the transceiver units of the stationary stations are connected to a power supply of energized infrastructure elements comprising traffic lights, streetlamps, information signs, advertising billboards, and/or other illuminations.

18. A navigation system according to claim 17, wherein the transceiver units of each stationary station are arranged between a base and an illumination means of the energized infrastructure element.

19. A navigation system according to claim 18, wherein the transceiver units of the stationary stations each comprise a connector which corresponds to a connector geometry of the illumination means of the energized infrastructure element to supply power to the stationary station.

20. A navigation system according to claim 16, wherein:
the stationary stations comprise a sensor; and
the sensor comprises a camera, a radar sensor, a LIDAR sensor or an ultrasound sensor.
